(19) United States
(12) Patent Application Publication
(10) Pub. No.: US 2007/0255959 A1
(43) Pub. Date: Nov. 1, 2007

(54) Communication apparatus and communication method thereof

(75) Inventors: Bae-Eun Jung, Yongin-si (KR); Hee-Jean Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/649,836

(22) Filed: Jan. 5, 2007

Related U.S. Application Data
(60) Provisional application No. 60/795,193, filed on Apr. 27, 2006.

(30) Foreign Application Priority Data
Jun. 7, 2006 (KR) 2006-50984

(51) Int. Cl. H04L 9/32; G06F 12/14; H04L 9/00; H04K 1/00; G06K 9/00; G06F 17/30; G06F 12/00; G06F 15/16; G06F 13/00; G06F 7/04; G06F 7/58; G06K 19/00; G11C 7/00

(52) U.S. Cl. 713/183; 713/184; 726/5; 726/6; 726/19

(57) ABSTRACT

A communication apparatus having a public key authentication function and a communication method thereof are disclosed. The communication apparatus includes a calculating unit to calculate a first user authentication data for authenticating public information, and a transmitting and receiving unit to transmit the calculated first user authentication data and the public information to be authenticated, and to transmit a password in a form in which a user characteristic input for authenticating the public information is reflected. Accordingly, if the parties to a communication unexpectedly request mutual authentication under an IP-based communication environment, the apparatus can safely authenticate the public information with a use of a user characteristic sensing channel.

### CROSS-REFERENCE TO RELATED APPLICATIONS

This application claims the benefit under 35 U.S.C. §119(e) of a U.S. Provisional Application No. 60/795193, filed Apr. 27, 2006, in the U.S. Patent and Trademark Office, and 35 U.S.C. §119(a) of a Korean Patent Application No. 10-2006-050984, filed Jun. 7, 2006, in the Korean Intellectual Property Office, the entire disclosure of which is hereby incorporated by reference.

### BACKGROUND OF THE INVENTION

1. Field of the Invention

The present invention relates to a communication apparatus, which can provide a public information authentication, and a communication method thereof. More particularly, the present invention relates to a communication apparatus, which can authenticate public information using a user characteristic sensing channel, and a communication method thereof.

2. Background of the Invention

With a diversification of communication environments, such as a moving network, a home network, and the like, a safety between the parties to a communication is one of important concerns. The IP-based communication environments are developing to improve the convenience of users, but have a problem in that it is possible for the third party to easily access. To prevent the problem, there is a need for a communication apparatus to authenticate whether an opposite communication apparatus, which is in the communication, is the very same communication apparatus, which is to be communicated at first. As methods of authenticating the communication apparatus, there are a public key infrastructure (PKI) on the basis of a Rivest Shamir Adlman (RSA), and a password-based public key agreement protocol.

The public key infrastructure is a security system environment, which provides an encryption and an electronic signature through a public key algorithm. The public key infrastructure encrypts transmitted data and decrypts received data using a public key comprising an encrypted key and a decrypted key.

Such a public key infrastructure includes a certificate authority to issue a certificate to the public key, a registration authority to confirm positions and identifies of users instead of the certificate authority in certificate requests of users, a directory to store and search the certificate/user's related information, a mutual certificate, and a certificate retraction list, and users to produce and verify an electronic signature using the public key in various applications and to perform encryption and decryption to data.

In the password-based public key agreement protocol, a communication apparatus should get a password in advance in an off-line environment.

However, in the state that communication apparatuses communicate in real time with each other, if the communication apparatuses unexpectedly request mutual authentication, it is difficult to authenticate the other parties to the communication using the password-based public key agreement protocol and the public key infrastructure.

Also, in the authentication method of using the public key infrastructure, there is a problem in that a procedure to register the certificate to the public key to the certificate authority is complicated, and if a communication apparatus does not possess the certificate, it is not possible to authenticate the communication apparatus.

### SUMMARY OF THE INVENTION

An aspect of the present invention is to address at least the above problems and/or disadvantages and to provide at least the advantages described below. Accordingly, an aspect of the present invention is to provide a communication apparatus having a public information authentication function, which when the parties to a communication unexpectedly request mutual authentication under an IP-based communication environment, can safely authenticate public information using a user characteristic sensing channel, and a communication method thereof.

According to an aspect of an exemplary embodiment of the present invention, a communication apparatus is provided. The communication apparatus comprises a calculating unit for calculating a first user authentication data for authenticating public information, and a transmitting and receiving unit for transmitting the calculated first user authentication data and the public information to be authenticated, and for transmitting a password in a form in which a user characteristic input for authenticating the public information is reflected.

The transmitting and receiving unit may transmit the first user authentication data prior to transmitting the password.

The transmitting and receiving unit may transmit the password after receiving an acknowledgement message to the first user authentication data.

The transmitting and receiving unit may receive the acknowledgement message to the first user authentication data in the form of one of audio data and image data in which the user characteristic is reflected.

The calculating unit may produce a random number, which is used to the calculation of the first user authentication data, and the transmitting and receiving unit may transmit the produced random number after receiving an acknowledgement message to the first user authentication data.

The transmitting and receiving unit may transmit the random number after transmitting the password.

The calculating unit may calculate the first user authentication data by applying the password, the random number and the public information to a Hash function.

The transmitting and receiving unit may transmit the password in the form of one of audio data and image data in which the user characteristic is reflected.

The password may be a one-time password, which is used when the public information is authenticated to allow a plurality of communication apparatuses to have the public information authenticated in intercommunication.

The calculating unit may produce a response to a random challenge, which is received, and the transmitting and receiving unit may transmit the produced response to the random challenge.

According to another aspect of an exemplary embodiment of the present invention, a communication method is provided. The method comprises calculating a first user authentication data for authenticating public information, and transmitting the calculated first user authentication data and the public information to be authenticated, and transmitting a password in a form in which a user characteristic input for authenticating the public information is reflected.

The transmitting may include transmitting the first user authentication data prior to transmitting the password.

The transmitting may include transmitting the password after receiving an acknowledgement message to the first user authentication data.

The transmitting may include transmitting the acknowledgement message to the first user authentication data in the form of one of audio data and image data in which the user characteristic is reflected.

The calculating may include producing a random number, which is used to the calculation of the first user authentication data, and the transmitting may include transmitting the produced random number after receiving an acknowledgement message to the first user authentication data.

The transmitting may include transmitting the random number after transmitting the password.

The calculating may include calculating the first user authentication data by applying the password, the random number and the public information to a Hash function.

The transmitting may include transmitting the password in the form of one of audio data and image data in which the user characteristic is reflected.

The password may be a one-time password, which is used when the public information is authenticated to allow a plurality of communication apparatuses to have the public information authenticated in intercommunication.

The calculating may include producing a response to a random challenge which is received, and the transmitting may include transmitting the produced response to the random challenge.

According to still another aspect of an exemplary embodiment of the present invention, a communication apparatus is provided. The apparatus comprises a transmitting and receiving unit for receiving a first user authentication data for authenticating public information and the public information, and for receiving a password in a form in which a user characteristic input for authenticating the public information is reflected, a calculating unit for calculating a second user authentication data on the basis of the password and the public information, which are received, and a displaying unit for displaying a comparison result between the received first user authentication data and the calculated second user authentication data.

The transmitting and receiving unit may receive the first user authentication data prior to receiving the password and the displaying unit may output at least one out of a message, an alarm and an icon acknowledging a receipt of the first user authentication data.

The transmitting and receiving unit may receive the password after transmitting an acknowledgement message to the first user authentication data.

The transmitting and receiving unit may transmit an acknowledgement message to the first user authentication data and an acknowledgement message to the password in the form of one of audio data and image data in which the user characteristic is reflected.

The transmitting and receiving unit may receive a random number, which is used to an authentication of the first user authentication data, after transmitting the acknowledgement message to the first user authentication data.

The calculating unit may calculate the second user authentication data by applying the received password, the received random number and the received public information to a Hash function.

The calculating unit may calculate a random challenge using the received public information, and the transmitting and receiving unit may transmit the calculated random challenge.

The transmitting and receiving unit may receive the password in the form of one of audio data and image data in which the user characteristic is reflected.

The communication apparatus may further include a comparing unit to compare whether the first user authentication data is substantially identical to the second user authentication data. In this case, the displaying unit may display the comparison result of the comparing unit to inform a user of the comparison result.

The transmitting and receiving unit may receive the first user authentication data and the public information once at first, and refuse to receive the first user authentication data and the public information after that time.

According to also another aspect of an exemplary embodiment of the present invention, there is provided a communication method including: receiving a first user authentication data for authenticating public information and the public information, and receiving a password in a form in which a user characteristic input for authenticating the public information is reflected, calculating a second user authentication data on the basis of the password and the public information, which are received, and displaying a comparison result between the received first user authentication data and the calculated second user authentication data.

The receiving may include receiving the first user authentication data prior to receiving the password and the displaying may include outputting at least one out of a message, an alarm and an icon acknowledging a receipt of the first user authentication data.

The receiving may include receiving the password after transmitting an acknowledgement message to the first user authentication data.

The receiving may include transmitting an acknowledgement message to the first user authentication data and a acknowledgement message to the password in the form of one of audio data and image data in which the user characteristic is reflected.

The receiving may include receiving a random number, which is used to an authentication of the first user authentication data, after transmitting a acknowledgement message to the first user authentication data.

The calculating may include calculating the second user authentication data by applying the received password, the received random number and the received public information to a Hash function.

The calculating may include calculating a random challenge using the received public information. In this case, the transmitting may include transmitting the calculated random challenge.

The receiving may include receiving the password in the form of one of an audio date and an image date in which the user characteristic is reflected.

The communication method may further include comparing whether the first user authentication data is substantially identical to the second user authentication data. In this case, the displaying may include displaying the comparison result of the comparing to inform a user of the comparison result.

The receiving may include receiving the first user authentication data and the public information once at first, and refusing to receive the first user authentication data and the public information after that time.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWING FIGURES

The above and other aspects, features, and advantages of certain exemplary embodiments of the present invention will become more apparent from the following description taken in conjunction with the accompanying drawings, wherein;

FIG. 1 is a block diagram illustrating an authentication system to which communication apparatuses according to an exemplary embodiment of the present invention are applied;

FIG. 2 is a flow chart illustrating a communication method according to an exemplary embodiment of the present invention, which is used in the authentication system; and

FIG. 3 is a flow chart illustrating a process of confirming whether a first communication apparatus possesses a secret key for a public key in the authentication system.

Throughout the drawings, it should be noted that the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

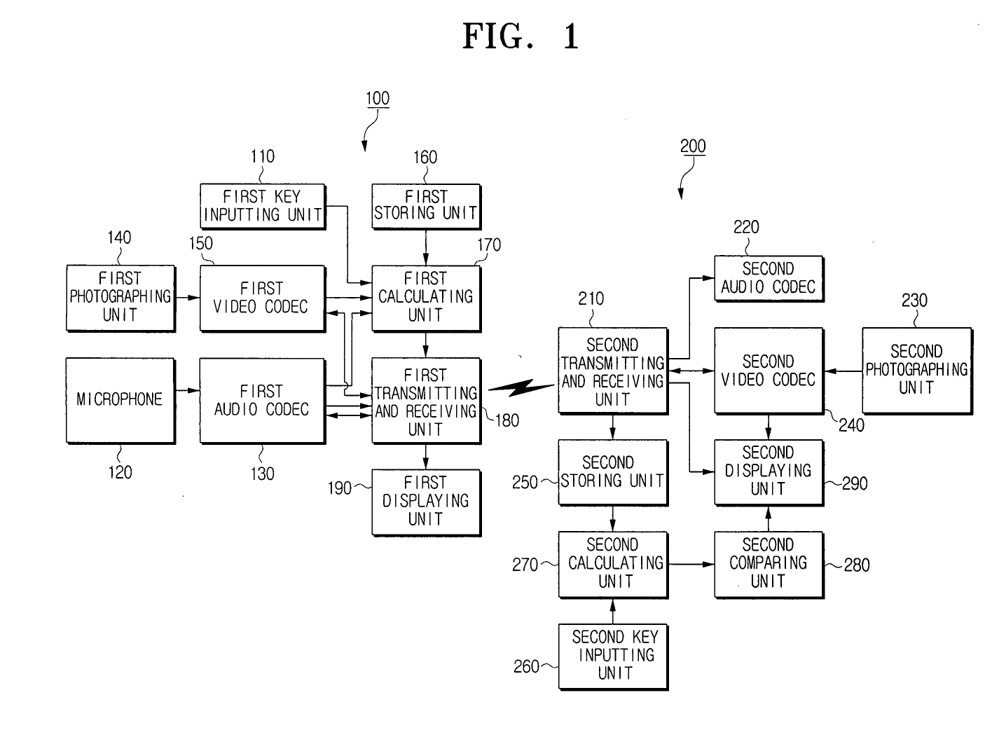

FIG. 1 is a block diagram illustrating an authentication system to which communication apparatuses according to an exemplary embodiment of the present invention are applied. Referring to FIG. 1, the authentication system includes a first communication apparatus 100 and a second communication apparatus 200, which can communicate with each other through a user characteristic sensing channel. Here, the user characteristic sensing channel refers to a channel, which transmits voice data or image data capable of recognizing users in intercommunication.

In the authentication system, for clarity and conciseness, a mutual authentication between the communication apparatuses to a public key, which is an example of public information, will be explained as an example of authentication. Here, it should be noted that the public key is merely an example of the public information, and the public information is not always limited to that.

First, referring to the first communication apparatus 100, the first communication apparatus 100 includes a first key inputting unit 110, a microphone 120, a first audio codec 130, a first photographing unit 140, a first video codec 150, a first storing unit 160, a first calculating unit 170, a first transmitting and receiving unit 180, and a first displaying unit 190.

The first key inputting unit 110 comprises a key button, a touch panel or the like, and receives a one-time password and required information from a user. Here, the one-time password refers to a password, which is used for authenticating the public information, such as, the public key, while the plurality of communication apparatus communicate with each other.

The microphone 120 converts an acoustic signal input from the outside into an electrical signal.

The first audio codec 130 converts data, such as a music, a voice, or the like, input from the microphone 120 from an analogue signal into a digital signal, which is recognizable by the first communication apparatus 100, and then compresses the converted data in a reference format. And, if necessary, the first audio codec 130 extracts the compressed data again, converts the extracted data from the digital signal into the analogue signal, and then outputs the converted data through a speaker (not illustrated).

The first photographing unit 140 receives an optic or light signal from an external subject for photography through a lens (not illustrated), and converts the received light signal into an electric signal.

And the first photographing unit 140 performs signal processing, such as a gain adjustment, a noise removal, a gamma adjustment, a luminance signal separation, and so on, on the electric signal.

The first video codec 150 compresses input data in a reference format, and if necessary, extracts the compressed data again.

In an exemplary implementation, the first video codec 150 compresses data input from the first photographing unit 140 in a reference format, and then transmits the compressed data to the first transmitting and receiving unit 180. Also, the first video codec 150 extracts image data of the second communication apparatus 200 input from the first transmitting and receiving unit 180, performs signal processing on the extracted image data, and then transmits the processed data to the first displaying unit 190.

The first storing unit 160 stores all sorts of programs required for operating the first communication apparatus 100, a cryptographic algorithm, and a public key and a Hash function of the first communication apparatus 100.

The first calculating unit 170 produces a random number R using a random function, and a first user authentication data H using the Hash function. Here, the first calculating unit 170 can produce a null as the random number R. The principal of producing the first user authentication data H will be described with reference to the following mathematical formula 1

H=Hash(K, R,PW) [Mathematical formula 1]

Here, H is the first user authentication data, Hash is the Hash function, K is the public key, R is the random number, and PW is the one-time password.

That is, the first calculating unit 150 produces the first user authentication data H by applying the one-time password received from the first inputting unit 110, the random number R, and the public key read from the first storing unit 160 to the Hash function.

Here, the Hash function refers to a function to compress an input value with an optional length into an output value with a reference length, and has properties as follows. It is not possible to calculatively find an input value to a given output value and to calculatively find another input value of producing the same output value to a given input value, on the Hash function. Also, it is not possible to calculatively find two different optional values of producing the same output value on the Hash function.

The Hash function of satisfying the properties as described as above is one of important functions, which are applied to an authentication, a denial prevention, an integrity, and the like of data. Accordingly, in an exemplary embodiment of the present invention, communication apparatuses, which communicate with the first communication apparatus 100, will be configured to share for the Hash function. That is, in the authentication system of FIG. 1, the first and the second communication apparatuses 100 and 200 share for the Hash function.

Also, since the Hash function is an example of one-way functions, an exemplary embodiment of the present invention may employ other one-way function as well as the Hash function.

The first transmitting and receiving unit 180 transmits the first user authentication data H and the random number R calculated by the first calculating unit 170 and the public key K read from the first storing unit 160 to the second communication apparatus 200. At this time, the first transmitting and receiving unit 180 transmits the first user authentication data H prior to transmitting the one-time password, and transmits the random number R after confirming a receipt of the one-time password from the second communication apparatus 200.

For example, the first user authentication data H, the public key K, and the random number R are transmitted through a network channel. Since the network channel is a channel to transmit and receive data, such as a text and the like, the first transmitting and receiving unit 180 transmits the first user authentication data H, the public key K, and the random number R in the form of text data.

Also, the first transmitting and receiving unit 180 receives a acknowledgement message to the transmitted first user authentication data from the second communication apparatus 200, and transmits and receives data, such as a voice, an image, a letter, and the like.

That is, the first transmitting and receiving unit 180 transmits image data and audio data received from the first video codec 150 and the first audio codec 130, respectively. For example, the acknowledgement message to the first user authentication data is received through the user characteristic sensing channel. Since the user characteristic sensing channel is a channel to transmit and receive an image and a voice through which a user can determine the other party's characteristics, the first transmitting and receiving unit 180 receives the acknowledgement message to the first user authentication data in the form of image data and voice data. For example, the user characteristic sensing channel and the network channel may be a physically identical channel, but an exemplary embodiment of the present invention is not limited to that.

The first displaying unit 190 includes a liquid display panel (LCD), and the like, and displays information on operations of the first communication apparatus 100, system information, operation conditions of the first communication apparatus 100, user interfaces, and the like. That is, the first displaying unit 190 displays the acknowledgement message to the first user authentication data received from the second communication apparatus 200, and an image signal of the second communication apparatus 200 received through the first transmitting and receiving unit 180.

Next, referring to the second communication apparatus 200, the second communication apparatus 200 includes a second transmitting and receiving unit 210, a second audio codec 220, a second photographing unit 230, a second video codec 240, a second storing unit 250, a second key inputting unit 260, a second calculating unit 270, a second comparing unit 280 and a second displaying unit 290.

The second transmitting and receiving unit 210 receive the first user authentication data H, the random number R and the public key K from the first communication apparatus 100. At this time, the second transmitting and receiving unit 210 transmits the first user authentication data H and the public key K once at first, and refuse to receive the first user authentication data H and the public key after that time. For example, the first user authentication data H, the public key K, and the random number R can be received through the network channel, but an exemplary embodiment of the present invention is not limited to that.

Also, the second transmitting and receiving unit 210 transmits a acknowledgement message to the first user authentication data H to the first communication apparatus 100 when receiving the first user authentication data H, and transmits and receives data, such as a voice, an image; a letter, and the like. When the first user authentication data H is received through the second transmitting and receiving unit 210, the second displaying unit 290 outputs at least one out of a message, an alarm, and an icon acknowledging a receipt of the first user authentication data. For example, the second transmitting and receiving unit 210 receives image data and audio data of the first communication apparatus 100 from the first communication apparatus 100, and transmits image data and audio data of the second communication apparatus 200 to the first communication apparatus 100. At this time, one of the image data and the audio data includes a one-time password, and the acknowledgement message to the first user authentication data H is transmitted through the user characteristic sensing channel.

Also, the second transmitting and receiving unit 210 transmits voice data or image data to acknowledge a receipt of the one-time password. That is, when receiving the one-time password, a user of the second communication apparatus 200 informs a user of the first communication apparatus 100 of the reception of the one-time password through a voice or an image.

The second audio codec 220 converts data, such as a music, a voice, or the like, input from the second transmitting and receiving unit 210 from an analogue signal into a digital signal, which is recognizable by the second communication apparatus 200, and then compresses the converted data in a reference format. And, if necessary, the second audio codec 220 extracts the compressed data again, converts the extracted data from the digital signal into the analogue signal, and then outputs the converted data through a speaker (not illustrated). According to this, the user can perceive the one-time password included in the audio data.

The second photographing unit 230 receives an optic or light signal from an external subject for photography through a lens (not illustrated), and converts the received light signal into an electric signal.

And the second photographing unit 230 performs signal processing, such as a gain adjustment, a noise removal, a gamma adjustment, a luminance signal separation, and the like, on the electric signal.

The second video codec 240 compresses input data in a reference format, and if necessary, extracts the compressed data again.

In an exemplary implementation, the second video codec 240 compresses data received from the second photographing unit 230 in the reference format, and then transmits the compressed data to the second transmitting and receiving unit 210. Also, the second video codec 240 extracts image data of the first communication apparatus 100 input from the second transmitting and receiving unit 210, performs signal processing on the extracted image data, and then transmits the processed data to the second displaying unit 290.

The second storing unit 250 stores the first user authentication data H and the public key K received from the second transmitting and receiving unit 210, and stores all sorts of programs required for operating the second communication apparatus 200, a cryptographic algorithm, a public key and a Hash function. The Hash function stored in the second storing unit 250 is shared with the first communication apparatus 100.

The second key inputting unit 260 comprises a key button, a touch panel or the like, and receives a one-time password and required information from a user. At this time, the one-time password input from the user is the very same one-time password, which is received from the first communication apparatus 100 and outputted through the speaker.

That is, if the one-time password input through the microphone 120 from the user of the first communication apparatus 100 is processed by the first video codec 130 and then transmitted to the second communication apparatus 200, the user of the second communication apparatus 200 perceives the one-time password received from the first communication apparatus 100, and inputs the received one-time password through the second key inputting unit 260.

The second calculating unit 270 calculates a second user authentication data H′ using the Hash function and the public key K read from the second storing unit 250, the one-time password PW received from the second key inputting unit 260, and the random number R. The principal of producing the second user authentication data H′ will be described with reference to the following mathematical formula 2.

H′=Hash(K, R,PW) [Mathematical formula 2]

Here, H′ is the second user authentication data, Hash is the Hash function, K is the public key, R is the random number, and PW is the one-time password.

That is, the second calculating unit 270 produces the second user authentication data H′ by applying the public key K read from the second storing unit 250, the one-time password received from the second key inputting unit 260, the random number R received from the second transmitting and receiving unit 210 to the Hash function.

The comparing unit 280 compares whether the first user authentication data H read from the second storing unit 250 is substantially identical to the second user authentication data H′ calculated by the second calculating unit 270. And the comparing unit 280 informs the user of the comparison result through the second displaying unit 280

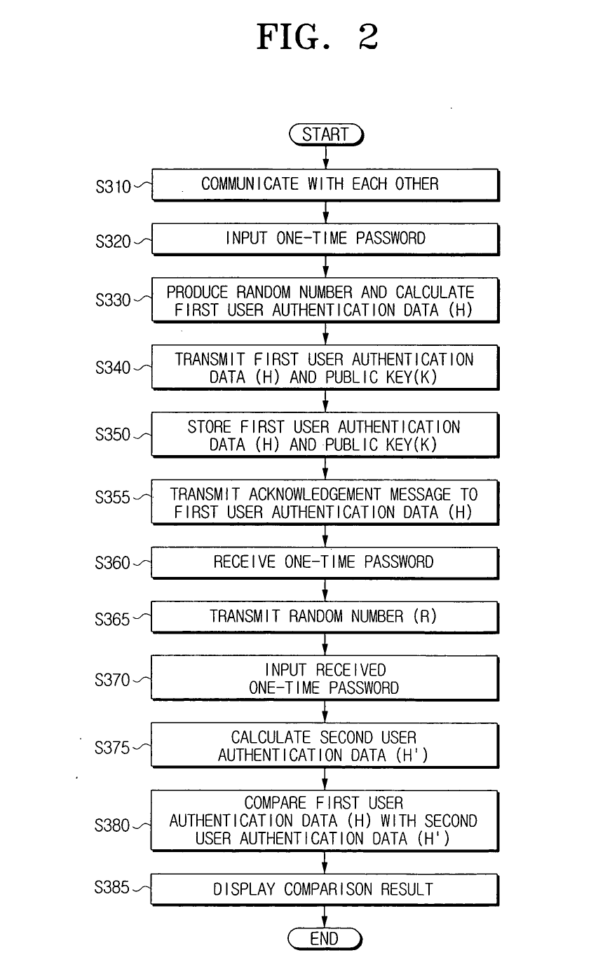

FIG. 2 is a flow chart illustrating a communication method according to an exemplary embodiment of the present invention, which is used in the authentication system.

Referring to FIG. 2, first, the first and the second communication apparatuses 100 and 200 communicate with each other through a user characteristic sensing channel at step S310. Here, the user characteristic sensing channel is a channel to transmit and receive an image and a voice through which users of the first and the second communication apparatuses 100 and 200 can determine the other party's characteristics. That is, the users of the first and the second communication apparatuses 100 and 200 are in an image or voice communication state, which they can determine the other party's characteristics.

Subsequently, the first key inputting unit 110 receives a one-time password from the user of the first communication apparatus 100 at step S320.

And then, the first calculating unit 170 produces a random number R using a random function, and calculates a first user authentication data H at step S330.

To be more specific, the first calculating unit 170 produces the first user authentication data H by applying the produced random number R, the one-time password PW received from the first key inputting unit 110, and the public key K read from the first storing unit 160 to the Hash function, as in the mathematical formula 1 described above. Here, the first and the second communication apparatuses 100 and 200 share for the Hash function.

Subsequently, the first transmitting and receiving unit 180 transmits the first user authentication data H and the public key K to the second communication apparatus 200 at step S340. At this time, the first transmitting and receiving unit 180 transmits the first user authentication data H and the public key K through a network channel. Here, the network channel and the user characteristic sensing channel may be a physically identical channel, but an exemplary embodiment of the present invention is not limited to that.

And then, the second transmitting and receiving unit 210 stores the first user authentication data H and the public key K received through the network channel in the second storing unit 250 at step S350. At this time, the second transmitting and receiving unit 210 receives the first user authentication data H and the public key K once at first, and refuses to receive the first user authentication data H and the public key K after that time.

Subsequently, the second transmitting and receiving unit 210 transmits an acknowledgement message to the received first user authentication data H to the first communication apparatus 100 at step S355. Here, the acknowledgement message to the first user authentication data H is transmitted through the user characteristic sensing channel.

That is, the second transmitting and receiving unit 210 transmits the acknowledgement message to the first user authentication data H in the form of image data and audio data.

And the second transmitting and receiving unit 210 receives the one-time password transmitted from the first communication apparatus 100 after the first communication apparatus 100 receives the acknowledgement message to the first user authentication data H at step S360.

That is, the second transmitting and receiving unit 210 receives a one-time password transmitted by a voice of the user of the first communication apparatus 100. At this time, the second transmitting and receiving unit 210 receives the one-time password through the user characteristic sensing channel.

To be more specific, when the user of the first communication apparatus 100 inputs the one-time password through the microphone 120, the first transmitting and receiving unit 180 transmits image data and audio data processed by the first video codec 150 and the first audio codec 130, respectively, through the user characteristic sensing channel to the second communication apparatus 200. Then, the second transmitting and receiving unit 210 receives the one-time password included in either the image data or the audio data. Here, the one-time password input through the microphone 120 is substantially identical to the one-time password input by the user at and through first key inputting unit 110.

When the one-time password is received, the second displaying unit 290 displays the received one-time password, and the second transmitting and receiving unit 210 transmits voice or image data of acknowledging a receipt of the one-time password to the first communication apparatus 100. That is, after receiving the one-time password, the user of the second communication apparatus 200 acknowledges the receipt of the one-time password to the user of the first communication apparatus 100 through a voice or an image.

After the acknowledgment to the receipt of the one-time password from the second communication apparatus 200, the first transmitting and receiving unit 180 transmits the random number R produced by the first calculating unit 170 at step S365. That is, the first transmitting and receiving unit 180 transmits the random number R used in the calculation of the first user authentication data H to the second communication apparatus 200. Here, the random number R is transmitted through the user characteristic sensing channel to the second communication apparatus 200.

When the random number R is received from the first communication apparatus 100, the second key inputting unit 260 receives the one-time password from the user of the second communication apparatus 200 at step S370. That is, the user of the second communication apparatus 200 inputs the one-time password received at the step 360 through the second key inputting unit 260.

Subsequently, the second calculating unit 270 calculates a second user authentication data H′ by applying the first user authentication data H, the public key K, the one-time password PW and the random number R to the Hash function at step S375.

That is, the second calculating unit 270 calculates the second user authentication data H′ by applying the public key read from the second storing unit 250, the random number R received from the second transmitting and receiving unit 210, and the one-time password PW received from the second key inputting unit 260 to the Hash function, as in the mathematical formula 2 described above.

And then, the comparing unit 280 compares whether the first user authentication data H read from the second storing unit 250 is substantially identical to the second user authentication data H′ calculated by the second calculating unit 270 (H=H′) at step S380.

Subsequently, the displaying unit 290 displays the comparison result of the comparing unit 280 to inform the user at step S385. According to this, it is possible for the second communication apparatus 200 to confirm whether the other party, which is in the communication at present, is the first communication apparatus 100. That is, the user of the second communication apparatus 200 can perceive whether the other party, which is in the communication at present, is the same other party, which she/he wants to communicate with her/him, or an intermediate invader, which she/he does not want to communicate with her/him.

Although in the communication method according to an exemplary embodiment of the present invention, the public key K is explained as transmitted along with the first user authentication data H at the step 340, an exemplary embodiment of the present invention is not limited to that. That is, the public key K can be transmitted at any one of the steps 320 through 385. For example, the public key K is not transmitted along with the first user authentication data H at the step 340, but along with the random number R at the step 365.

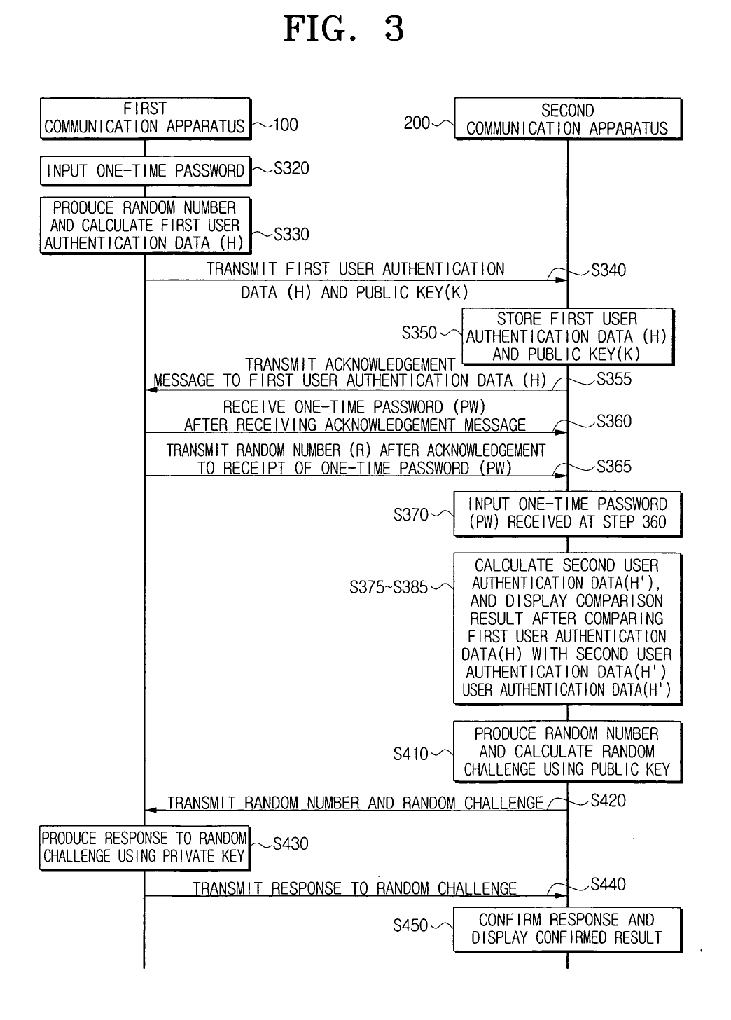

FIG. 3 is a flow chart illustrating a process of confirming whether a first communication apparatus possesses a secret key for a public key in the authentication system as described above.

Referring to FIG. 3, since processes of authenticating the public key in the state at step S310 which the first and the second communication apparatuses 100 and 200 communicates with each other are the same as those of the steps S320 through S385, descriptions thereof will be omitted, and hereinafter, processes after displaying the comparison result between the first and the second user authentication data as the step 385 will be described.

First, the second calculating unit 270 produces a random number and calculates a random challenge using the public key of the first communication apparatus 100 at step S410, and then transmits the produced random number and the calculated random challenge at step S420.

Here, the random challenge refers to a question message to confirm whether the first communication apparatus 100 possesses a secret key for the public key. Since a method of calculating the random challenge is the same as a conventional method used in the art of key authentication, descriptions thereof will be omitted.

Subsequently, the first calculating unit 170 produces a response to the random challenge received through the first transmitting and receiving unit 180, using a private key of the first communication apparatus 100 at step S430, and transmits the produced response to the second communication apparatus 200 at step S440.

And the second comparing unit 280 determines whether the response to the random challenge received through the second transmitting and receiving unit 210 is a right response, and then displays the determination result on the second displaying unit 290 at step S450.

That is, the second comparing unit 280 determines whether the response to the random challenge is a response, which meets the question message transmitted to confirm whether the first communication apparatus 100 possesses the secret key for the public key at the step S420, and displays the determination result on the second displaying unit 290 to inform the user. According to this, the user of the second communication apparatus 200 can perceive whether the first communication apparatus 100 possesses the secret key for the public key.

In the communication method according to an exemplary embodiment of the present invention and the authentication system employing the same, one communication apparatus is explained as authenticating the public information, but an exemplary embodiment of the present invention is not limited to that. An exemplary implementation of the present invention is applicable to public information authentication of a plurality of communication apparatuses, each of which a corresponding user want to authenticate a public information. That is, the first communication apparatus as well as the second communication apparatus can authenticate the public information by applying the communication method of an exemplary embodiment of the present invention to a Key agreement protocol of Diffie-Hellman.

Also, the communication method according to an exemplary embodiment of the present invention and the authentication system employing the same can be used even when authenticating the public information on the basis of user characteristics, such as a facial recognition, a fingerprint recognition, and the like.

Although the present invention has been shown and described with reference to certain exemplary embodiments thereof, it will be understood by those skilled in the art that various modifications and changes in forms and details can be made therein without departing from the spirit and scope of the invention as defined by the appended claims and their equivalents. Therefore, it shall be considered that such modifications, changes and equivalents thereof are all included within the scope of the present invention.

What is claimed is:

1. A communication apparatus comprising:
a calculating unit for calculating a first user authentication data for authenticating public information; and
a transmitting and receiving unit for transmitting the calculated first user authentication data and the public information to be authenticated, and transmitting a password comprising a form indicative of a user characteristic input for authenticating the public information.

2. The communication apparatus of claim 1, wherein the transmitting and receiving unit transmits the first user authentication data prior to transmitting the password.

3. The communication apparatus of claim 2, wherein the transmitting and receiving unit transmits the password after receiving an acknowledgement message to the first user authentication data.

4. The communication apparatus of claim 1, wherein the transmitting and receiving unit receives an acknowledgement message to the first user authentication data, a form of the acknowledgement message comprising at least one of audio data and image data indicative of the user characteristic.

5. The communication apparatus of claim 1,
wherein the calculating unit produces a random number for the calculation of the first user authentication data,
wherein the transmitting and receiving unit transmits the random number after receiving an acknowledgement message to the first user authentication data.

6. The communication apparatus of claim 5, wherein the transmitting and receiving unit transmits the random number after transmitting the password.

7. The communication apparatus of claim 5, wherein the calculating unit calculates the first user authentication data by applying the password, the random number and the public information to a Hash function.

8. The communication apparatus of claim 1, wherein the transmitting and receiving unit transmits the password in the form of at least one of audio data and image data indicative of the user characteristic.

9. The communication apparatus of claim 1, wherein the password comprises a one-time password used when the public information is authenticated to allow a plurality of communication apparatuses to have the public information authenticated in intercommunication.

10. The communication apparatus of claim 1, wherein the calculating unit produces a response to a random challenge received, wherein the transmitting and receiving unit transmits the produced response to the random challenge.

11. A communication method comprising:
calculating a first user authentication data for authenticating public information; and
transmitting the calculated first user authentication data and the public information to be authenticated, and transmitting a password comprising a form indicative of a user characteristic input for authenticating the public information.

12. The communication method of claim 11, wherein the transmitting of the calculated first user authentication data and the public information comprises transmitting the first user authentication data prior to transmitting the password.

13. The communication method of claim 12, wherein the transmitting of the calculated first user authentication data and the public information comprises transmitting the password after receiving an acknowledgement message to the first user authentication data.

14. The communication method of claim 11, wherein the transmitting of the calculated first user authentication data and the public information comprises transmitting an acknowledgement message to the first user authentication data, a form of the acknowledgement message comprising at least one of audio data and image data indicative of the user characteristic.

15. The communication method of claim 11,
wherein the calculating of a first user authentication data comprises producing a random number for the calculation of the first user authentication data,
wherein the transmitting of the calculated first user authentication data and the public information comprises transmitting the random number after receiving an acknowledgement message to the first user authentication data.

16. The communication method of claim 15, wherein the transmitting of the calculated first user authentication data and the public information comprises transmitting the random number after transmitting the password.

17. The communication method of claim 15, wherein the calculating of a first user authentication data comprises calculating the first user authentication data by applying the password, the random number and the public information to a Hash function.

18. The communication method of claim 11, wherein the transmitting of the calculated first user authentication data and the public information comprises transmitting the password in the form comprising at least one of audio data and image data indicative of the user characteristic.

19. The communication method of claim 11, wherein the password comprises a one-time password used when the public information is authenticated to allow a plurality of communication apparatuses to have the public information authenticated in intercommunication.

20. The communication method of claim 11, wherein the calculating of a first user authentication data comprising:
producing a response to a random-challenge, which is received,
wherein the transmitting comprises transmitting the produced response to the random-challenge.

21. A communication apparatus comprising:
a transmitting and receiving unit for receiving a first user authentication data for authenticating public information and the public information, and for receiving a password comprising a form indicative of a user characteristic input for authenticating the public information;
a calculating unit for calculating a second user authentication data on the basis of the received password and the public information; and
a displaying unit for displaying a comparison result between the received first user authentication data and the calculated second user authentication data.

22. The communication apparatus of claim 21, wherein the transmitting and receiving unit receives the first user authentication data prior to receiving the password, and the displaying unit outputs at least one of a message, an alarm and an icon acknowledging a receipt of the first user authentication data.

23. The communication apparatus of claim 22, wherein the transmitting and receiving unit receives the password after transmitting an acknowledgement message to the first user authentication data.

24. The communication apparatus of claim 21, wherein the transmitting and receiving unit transmits an acknowledgement message to the first user authentication data and an acknowledgement message to the password in the form comprising at least one of audio data and image data indicative of the user characteristic.

25. The communication apparatus of claim 24, wherein the transmitting and receiving unit receives a random number for an authentication of the first user authentication data, after transmitting the acknowledgement message to the first user authentication data.

26. The communication apparatus of claim 25, wherein the calculating unit calculates the second user authentication data by applying the received password, the received random number and the received public information to a Hash function.

27. The communication apparatus of claim 21, wherein the calculating unit calculates a random challenge using the received public information, wherein the transmitting and receiving unit transmits the calculated random challenge.

28. The communication apparatus of claim 21, wherein the transmitting and receiving unit receives the password in a form comprising at least one of audio data and image data indicative of the user characteristic.

29. The communication apparatus of claim 21, further comprising:
a comparing unit for comparing whether the first user authentication data is substantially identical to the second user authentication data,
wherein the displaying unit displays the comparison result of the comparing unit to inform a user of the comparison result.

30. The communication apparatus of claim 21, wherein the transmitting and receiving unit receives the first user authentication data and the public information a first time, and refuses to receive the first user authentication data and the public information after the first time.

31. A communication method comprising:
receiving a first user authentication data for authenticating public information and the public information, and receiving a password comprising a form indicative of a user characteristic input for authenticating the public information;
calculating a second user authentication data on the basis of the received password and the public information; and
displaying a comparison result between the received first user authentication data and the calculated second user authentication data.

32. The communication method of claim 31, wherein the receiving of a first user authentication data comprises receiving the first user authentication data prior to receiving the password, and the displaying comprises outputting at least one out of a message, an alarm and an icon acknowledging a receipt of the first user authentication data.

33. The communication method of claim 32, wherein the receiving of a first user authentication data comprises receiving the password after transmitting an acknowledgement message to the first user authentication data.

34. The communication method of claim 31, wherein the receiving of a first user authentication data comprises transmitting an acknowledgement message to the first user authentication data and an acknowledgement message to the password, a form of the acknowledgement message comprising at least one of audio data and image data indicative of the user characteristic.

35. The communication method of claim 31, wherein the receiving of a first user authentication data comprises receiving a random number for an authentication of the first user authentication data, after transmitting an acknowledgement message to the first user authentication data.

36. The communication method of claim 35, wherein the calculating of a second user authentication data comprises calculating the second user authentication data by applying the received password, the received random number and the received public information to a Hash function.

37. The communication method of claim 31, wherein the calculating of a second user authentication data comprises calculating a random challenge using the received public information, wherein the transmitting comprises transmitting the calculated random challenge.

38. The communication method of claim 31, wherein the receiving of a first user authentication data comprises receiving the password in a form comprising at least one of audio data and image data indicative of the user characteristic.

39. The communication method of claim 31, further comprising:
comparing whether the first user authentication data is substantially identical to the second user authentication data,
wherein the displaying comprises displaying the comparison result of the comparing to inform a user of the comparison result.

40. The communication method of claim 31, wherein the receiving of a first user authentication data comprises receiving the first user authentication data and the public information a first time, and refusing to receive the first user authentication data and the public information after the first time.
